(19) United States
(12) Patent Application Publication
(10) Pub. No.: US 2026/0369010 A1
(43) Pub. Date: Nov. 19, 2026

(54) BLOCK-BASED MESH SIMPLIFICATION

(71) Applicant: QUALCOMM Incorporated, San Diego, CA (US)

(72) Inventors: Adithya Reddy NALLABOLU, San Diego, CA (US); Gokce DANE, San Diego, CA (US); Upal MAHBUB, El Cajon, CA (US); Pirazh KHORRAMSHAHI, San Diego, CA (US); Mehul ARORA, San Diego, CA (US)

(21) Appl. No.: 19/208,507

(22) Filed: May 14, 2025

(51) Int. Cl. G06T 17/20; G06T 17/10

(52) U.S. Cl. CPC G06T 17/205; G06T 17/10; G06T 2210/36

(57) ABSTRACT

Systems and techniques are described for image processing. For example, a computing device can generate internal simplified meshes based on block meshes for blocks representing a scene. The computing device can generate unsimplified boundary meshes for the blocks based on the internal simplified meshes. The computing device can generate simplified boundary meshes based on the unsimplified boundary meshes. The computing device can generate simplified meshes by embedding simplified boundaries of each of the simplified boundary meshes into a respective internal simplified mesh. The computing device can generate a simplified global mesh for the blocks by merging the simplified meshes.

### FIELD

The present disclosure generally relates to image processing. For example, aspects of the present disclosure relate to block-based mesh simplification.

### BACKGROUND

In recent decades, there has been a demand for 3D content for computer graphics, virtual reality, and communications. Traditional systems for constructing 3D models use a significant amount of computational resources, memory, and bandwidth, and in some cases generate significant heat in the process. Recent decades have also shown a demand for performing more computing tasks on portable computing devices rather than on bulky stationary computing systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for image processing. In some aspects, an apparatus for image processing is provided. The apparatus includes at least one memory and at least one processor coupled to the at least one memory and configured to: generate a plurality of internal simplified meshes based on a plurality of block meshes for a plurality of blocks representing a scene, wherein each of the plurality of internal simplified meshes is associated with a respective block of the plurality of blocks; generate, based on the plurality of internal simplified meshes, a plurality of unsimplified boundary meshes for the plurality of blocks, wherein each of the plurality of unsimplified boundary meshes is associated with a respective block of the plurality of blocks; generate, based on the plurality of unsimplified boundary meshes, a plurality of simplified boundary meshes, wherein each of the plurality of simplified boundary meshes is associated with a respective block of the plurality of blocks; generate a plurality of simplified meshes by embedding simplified boundaries of each of the plurality of simplified boundary meshes into a respective internal simplified mesh, wherein each of the plurality of simplified meshes is associated with a respective block of the plurality of blocks; and generate a simplified global mesh for the plurality of blocks by merging the plurality of simplified meshes.

In some aspects, a method for image processing is provided. The method includes: generating a plurality of internal simplified meshes based on a plurality of block meshes for a plurality of blocks representing a scene, wherein each of the plurality of internal simplified meshes is associated with a respective block of the plurality of blocks; generating, based on the plurality of internal simplified meshes, a plurality of unsimplified boundary meshes for the plurality of blocks, wherein each of the plurality of unsimplified boundary meshes is associated with a respective block of the plurality of blocks; generating, based on the plurality of unsimplified boundary meshes, a plurality of simplified boundary meshes, wherein each of the plurality of simplified boundary meshes is associated with a respective block of the plurality of blocks; generating a plurality of simplified meshes by embedding simplified boundaries of each of the plurality of simplified boundary meshes into a respective internal simplified mesh, wherein each of the plurality of simplified meshes is associated with a respective block of the plurality of blocks; and generating a simplified global mesh for the plurality of blocks by merging the plurality of simplified meshes.

In some aspects, a non-transitory computer-readable medium is provided having stored thereon instructions that, when executed by at least one processor, cause the at least one processor to: generate a plurality of internal simplified meshes based on a plurality of block meshes for a plurality of blocks representing a scene, wherein each of the plurality of internal simplified meshes is associated with a respective block of the plurality of blocks; generate, based on the plurality of internal simplified meshes, a plurality of unsimplified boundary meshes for the plurality of blocks, wherein each of the plurality of unsimplified boundary meshes is associated with a respective block of the plurality of blocks; generate, based on the plurality of unsimplified boundary meshes, a plurality of simplified boundary meshes, wherein each of the plurality of simplified boundary meshes is associated with a respective block of the plurality of blocks; generate a plurality of simplified meshes by embedding simplified boundaries of each of the plurality of simplified boundary meshes into a respective internal simplified mesh, wherein each of the plurality of simplified meshes is associated with a respective block of the plurality of blocks; and generate a simplified global mesh for the plurality of blocks by merging the plurality of simplified meshes.

In some aspects, an apparatus for image processing is provided. The apparatus includes: means for generating a plurality of internal simplified meshes based on a plurality of block meshes for a plurality of blocks representing a scene, wherein each of the plurality of internal simplified meshes is associated with a respective block of the plurality of blocks; means for generating, based on the plurality of internal simplified meshes, a plurality of unsimplified boundary meshes for the plurality of blocks, wherein each of the plurality of unsimplified boundary meshes is associated with a respective block of the plurality of blocks; means for generating, based on the plurality of unsimplified boundary meshes, a plurality of simplified boundary meshes, wherein each of the plurality of simplified boundary meshes is associated with a respective block of the plurality of blocks; means for generating a plurality of simplified meshes by embedding simplified boundaries of each of the plurality of simplified boundary meshes into a respective internal simplified mesh, wherein each of the plurality of simplified meshes is associated with a respective block of the plurality of blocks; and means for generating a simplified global mesh for the plurality of blocks by merging the plurality of simplified meshes.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system, which may include a central processing unit (CPU), in accordance with some aspects of the disclosure.

FIG. 2 is a diagram illustrating an example of a 3D surface reconstruction of a scene modeled as a volume grid, in accordance with some aspects of the disclosure.

FIG. 3 is a diagram illustrating an example of a hash mapping function for indexing blocks (e.g., voxel blocks) in a volume grid, in accordance with some aspects of the disclosure.

FIG. 4 is a diagram illustrating an example of a block (e.g., a voxel block), in accordance with some aspects of the disclosure.

FIG. 5 is a diagram illustrating an example of a truncated signed distance function (TSDF) volume reconstruction, in accordance with some aspects of the disclosure.

FIG. 6 is a diagram illustrating an example of a process for block-based mesh simplification, in accordance with some aspects of the disclosure.

FIG. 7 is a diagram illustrating an example of a detailed process for block-based mesh simplification, in accordance with some aspects of the disclosure.

FIG. 8 is a diagram illustrating an example of a hardware flow for block-based mesh simplification, in accordance with some aspects of the disclosure.

FIG. 9 is a diagram illustrating an example of a process for extracting boundaries in the process of FIG. 7, in accordance with some aspects of the disclosure.

FIG. 10 is a diagram illustrating an example of a process for extracting a boundary mesh between two blocks in the process of FIG. 9, in accordance with some aspects of the disclosure.

FIG. 11 is a diagram illustrating an example of a process for embedding boundaries in the process of FIG. 7, in accordance with some aspects of the disclosure.

FIG. 12 is a diagram illustrating an example of a process for mesh simplification in the process of FIG. 7, in accordance with some aspects of the disclosure.

FIG. 13 is a diagram illustrating an example of mesh simplification, in accordance with some aspects of the disclosure.

FIG. 14 is a conceptual diagram illustrating representations of surface extraction and mesh generation at a voxel level, in accordance with some aspects of the disclosure.

FIG. 15 is a diagram illustrating an example showing parts of a block, in accordance with some aspects of the disclosure.

FIG. 16 is a flow diagram illustrating an example of a process for block-based mesh simplification, in accordance with some aspects of the disclosure.

FIG. 17 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, in recent decades, there has been a demand for three-dimensional (3D) content for computer graphics, virtual reality, and communications, triggering a change in emphasis for the requirements. Traditional systems for constructing 3D models use a significant amount of computational resources, memory, and bandwidth, and in some cases generate significant heat in the process. Recent decades have also shown a demand for performing more computing tasks on portable computing devices rather than on bulky stationary computing systems.

In some cases, volume blocks (e.g., voxel blocks) can be utilized to reconstruct a 3D scene from two-dimensional (2D) images, such as stereo images obtained from a stereo camera. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some examples, a system can perform 3D reconstruction (3DR) using depth frames and an associated live camera pose estimate for 3D scene reconstruction. In some cases, when performing 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle). In some cases, the scene can be divided into a dense volumetric representation (as opposed to a sparse volumetric representation).

In one illustrative example, a system can perform 3DR to reconstruct a 3D scene from 2D depth frames and color frames. The system can divide the scene into 3D blocks (e.g., voxel blocks or volume blocks, as noted previously). For example, the system may project each voxel block onto a 2D depth frame and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

As mentioned, 3DR is a fundamental task to understand the geometry of a 3D scene, which can enable the development of many interesting use cases, including plane detection, obstacle avoidance, occlusion rendering, etc. In this task, 3D surfaces can be represented by a triangular mesh that consists of vertices and faces or triangles. In case a user is interested in recovering fine details on surfaces with sharp edges, the resulting triangular mesh can have a significant number of vertices and faces (e.g., in the realm of millions), which can be challenging to manage, in particular, for an edge device, such as a mobile device. The situation can be exacerbated for a live 3DR (e.g., a block-based 3D reconstruction), where the user incrementally and continuously scans the scene. To address this issue, mesh simplification has been employed to ensure that whenever an initial mesh is extracted for a scene (e.g., which is typically the outcome of the marching cube algorithm), then the mesh can be simplified to have a fewer number of vertices and faces to lighten the computational load for the down-stream tasks.

Currently, in 3DR, there is a need for reducing the size of the mesh to allow for less storage, faster rendering, simpler manipulation, bandwidth (BW) savings, and power savings. As such, design goals and properties for mesh simplification can include efficiency (e.g., memory and logic efficiency) and producing a sufficient approximation (e.g., geometrically and visually) of the scene.

The benefits of mesh simplification can become greater if the technique can be hardened to run using a low power and with a low latency. However, this hardening can be very challenging due to a number of different factors. In one or more examples, one factor can involve irregular data access. For example, irregular data access can occur because the memory access for mesh simplification is not linear (e.g., when collapsing an edge of a surface, triangles connected to each of the vertices of the mesh may be accessed in memory in a non-linear fashion).

In some examples, another factor can involve the requirement of a sizeable memory. For example, a global simplification of all of the meshes of a scene at once may not be feasible due to hardware implementations because of local cache and memory constraints (e.g., the software implementation for a global simplification may need to access greater than six (6) megabytes (MB) of memory for a one million vertex-sized mesh for multiple iterations). Tiling-based simplification can help for memory reduction, but requires keeping track of boundary information for the local mesh as internal metadata. The metadata for each vertex (e.g., such as Q values to derive a quadratic error) and triangle (e.g., such as edge collapse errors) can require a significant amount of memory.

In one or more examples, another factor can involve the compute complexity (e.g., when iterating over all triangles of a mesh for a large number of iterations for a greedy approach). In some examples, another factor can involve enabling an incremental mesh simplification. For example, given an existing simplified mesh, when a surface update is needed for a few blocks, a mesh simplification may need to be performed from scratch (e.g., without reusing the previously simplified mesh) because there may not be a 1-1 correspondence between previously simplified meshes and newly updated block meshes.

Currently, a major issue in block-based (or any tiling-based) mesh simplification is the handling of the block boundaries for mesh consistency. Keeping the boundary vertices fixed can result in blocking artifacts, and can significantly limit the compression ratio, as there can be a large number of such vertices. On the other hand, allowing the boundary vertices to simplify locally can result in disjointed blocks that collapse inwards. Furthermore, stitching neighboring blocks together at a boundary after a local mesh simplification can be very challenging. For example, in many instances, this stitching can result in boundary artifacts.

As such, improved systems and techniques for mesh simplification for 3DR can be beneficial.

In some aspects of the present disclosure, systems, apparatuses, methods (also referred to as processes), and computer-readable media (collectively referred to herein as “systems and techniques”) are described herein for block-based mesh simplification.

Various aspects relate generally to image processing. Some aspects more specifically relate to systems and techniques that provide a practical solution (e.g., a two-step solution) for the boundary simplification issue by employing a block-based approach. In some examples, a block-based boundary-preserving local mesh simplification or block internal mesh simplification is first applied on meshes extracted from the TSDF blocks. The blocks, therefore, can be processed independently in parallel, if parallel processing is feasible, After the local processing, the boundary can be extracted by merging the boundary vertices between two neighboring blocks and extracting the triangles connected to the boundary vertices and other vertices connected to those triangles. Simplified meshes can be created by embedding the simplified boundary into the internally simplified local meshes. A global mesh can then be created by concatenating the local meshes.

Particular aspects of the subject matter described in this disclosure can be implemented to realize one or more of the following potential advantages. In one or more examples, the systems and techniques have the benefit of providing a scalable design (e.g., which includes many different knobs to customize the solution for different power, latency, and bandwidth scenarios). In some examples, the systems and techniques have the benefit of having a minimum amount of artifacts at the block boundaries (e.g., unlike boundary stitching approaches). In one or more examples, the systems and techniques have the benefit of having the capability to achieve a high compression ratio (e.g., unlike block-boundary preserving approaches). In one or more examples, the systems and techniques have the benefit of providing a full, continuous mesh after the mesh simplification. In some examples, the systems and techniques have the benefit of supporting an incremental mesh simplification (e.g., whereas other approaches do not address this aspect).

In one or more examples, during operation of the systems and techniques for block-based mesh simplification, one or more processors can generate, based on surface extraction of a plurality of blocks representing a scene, a respective block mesh for each block of the plurality of blocks. The one or more processors can generate, based on mesh simplification of each respective block mesh, a plurality of internal simplified meshes for the plurality of blocks. Each internal simplified mesh of the plurality of internal simplified meshes can be associated with a respective block of the plurality of blocks. The one or more processors can generate, based on the plurality of internal simplified meshes (e.g., a pair of internally simplified meshes that share a face along any of horizontal (x), vertical (y), and depth (z) axes), a plurality of unsimplified boundary meshes for the plurality of blocks. For example, an unsimplified mesh can be extracted between a pair of internally simplified meshes that share a face along any of the x, y, and z axes. Each unsimplified boundary mesh of the plurality of unsimplified boundary meshes can be associated with a respective block of the plurality of blocks. The one or more processors can generate, based on mesh simplification of the plurality of unsimplified boundary meshes, a plurality of simplified boundary meshes. Each simplified boundary mesh of the plurality of simplified boundary meshes can be associated with a respective block of the plurality of blocks. The one or more processors can generate, based on embedding simplified boundaries of each simplified boundary mesh into a respective internal simplified mesh, a plurality of simplified meshes. Each simplified mesh of the plurality of simplified meshes can be associated with a respective block of the plurality of blocks. The one or more processors can generate, based on merging the plurality of simplified meshes, a simplified global mesh for the plurality of blocks.

In one or more examples, each block of the plurality of blocks can be a truncated signed distance function (TSDF) volume. In some examples, the surface extraction can be based on a marching cubes algorithm.

In some examples, each block mesh of the respective block meshes can include a plurality of respective vertices and a plurality of respective triangles. In one or more examples, generating the respective internal simplified mesh for each block of the plurality of blocks can be further based on simplifying vertices of the plurality of respective vertices of the respective block meshes located internal of the plurality of blocks. In some examples, simplifying the vertices of the plurality of respective vertices of the respective block meshes located internal of the plurality of blocks can be based on a quadric error measure.

In one or more examples, each internal simplified mesh of the plurality of internal simplified meshes can include a plurality of respective vertices and a plurality of respective triangles. In some examples, generating each unsimplified boundary mesh associated with a respective block of the plurality of blocks can be further based on merging vertices of the plurality of respective vertices located on boundaries of neighboring blocks of the plurality of blocks. In one or more examples, generating each unsimplified boundary mesh associated with a respective block of the plurality of blocks can be further based on extracting triangles of the plurality of respective triangles connected to vertices of the plurality of respective vertices located on boundaries of the plurality of blocks. In some examples, generating each unsimplified boundary mesh associated with a respective block of the plurality of blocks can be further based on extracting vertices of the plurality of respective vertices connected to the triangles of the plurality of respective triangles extracted from a respective internal simplified meshes of the plurality of internal simplified meshes.

In some examples, each unsimplified boundary mesh of the plurality of unsimplified boundary meshes can include a plurality of respective vertices and a plurality of respective triangles. In one or more examples, generating each simplified boundary mesh associated with a respective block of the plurality of blocks can be further based on simplifying vertices of the plurality of respective vertices of a respective unsimplified boundary mesh of the plurality of unsimplified boundary meshes located on boundaries of the plurality of blocks.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

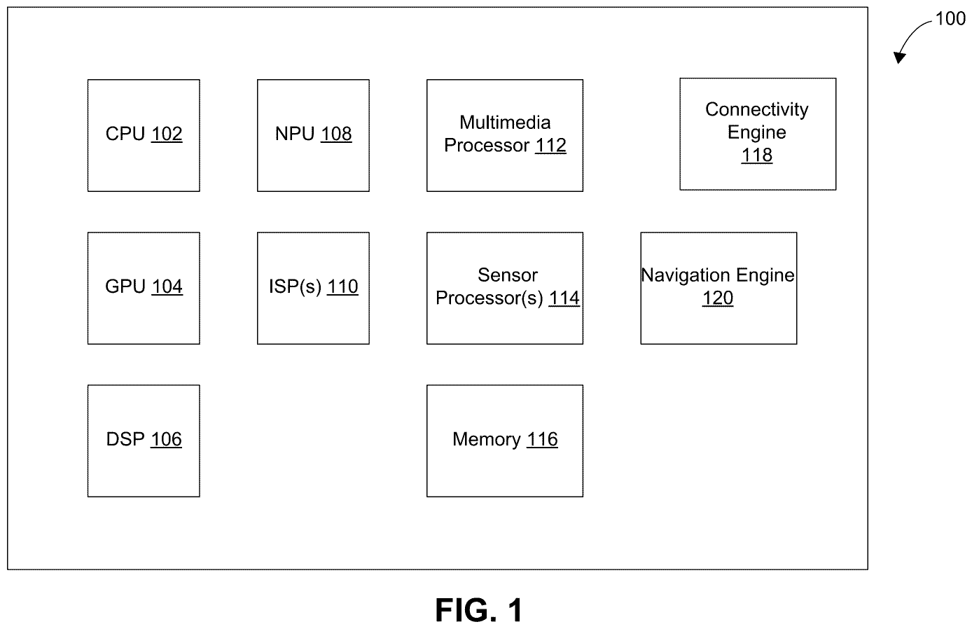

FIG. 1 illustrates an example implementation of a system 100, which may include a central processing unit (CPU), configured to perform one or more of the functions described herein. System 100, which may include a central processing unit (CPU 102) (which may be a multi-core CPU). Parameters or variables (e.g., neural signals and synaptic weights), system parameters associated with a computational device (e.g., neural network with weights), task information, among other information may be stored in a memory block associated with a neural processing unit (NPU 108), in a memory block associated with a CPU 102, in a memory block associated with a graphics processing unit (GPU 104), in a memory block associated with a digital signal processor (DSP 106), in a memory 116, and/or may be distributed across multiple blocks. Instructions executed at the CPU 102 may be loaded from a program memory associated with the CPU 102 or may be loaded from memory 116.

The system 100 may also include additional processing blocks tailored to specific functions, such as the GPU 104, the DSP 106, a connectivity engine 118, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, the DSP 106, and/or the GPU 104. The system 100 may also include one or more sensor processor(s) 114, one or more image signal processors (ISP(s) 110), and/or navigation engine 120, which may include a global positioning system. In some examples, the sensor processor(s) 114 can be associated with or connected to one or more sensors for providing sensor input(s) to the sensor processor(s) 114. For example, the one or more sensors and sensor processor(s) 114 can be provided in, coupled to, or otherwise associated with a same computing device.

The system 100 may be implemented as a system on a chip (SOC). The system 100 may be based on an Advanced Reduced Instruction Set Computer (RISC) Machine (ARM) instruction set. The system 100 and/or components thereof may be configured to perform mesh simplification techniques according to aspects of the present disclosure discussed herein. For example, the system 100 and/or components thereof may be configured to implement block-based mesh simplification techniques as described herein and/or according to aspects of the present disclosure.

As previously mentioned, there has been a demand for 3D content for computer graphics, virtual reality, and communications. Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

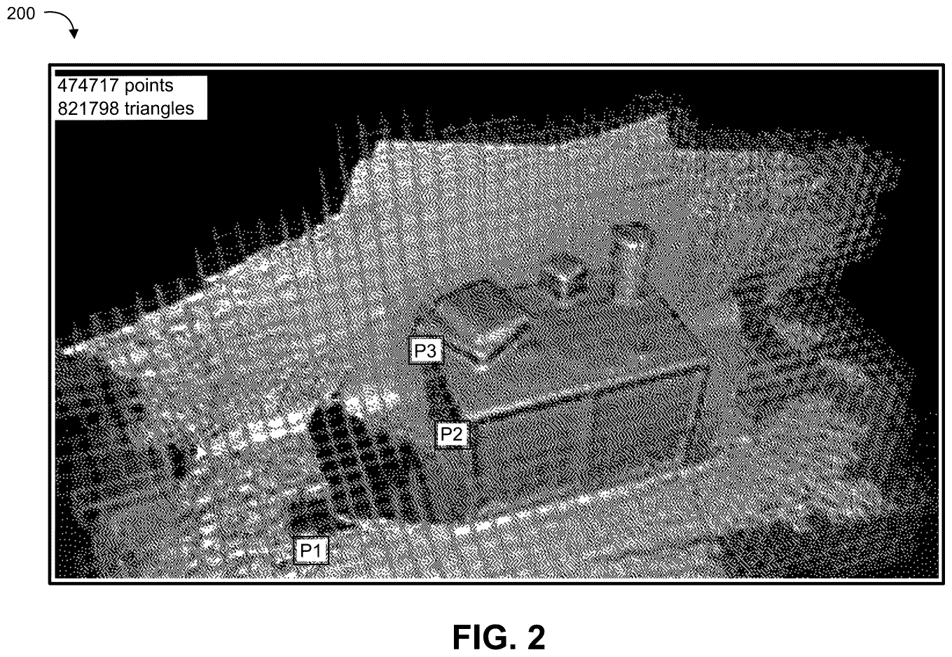

FIG. 2 shows an example of a scene that has been modeled as a 3D sparse volumetric representation for 3DR. In particular, FIG. 2 is a diagram illustrating an example of a 3D surface reconstruction 200 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

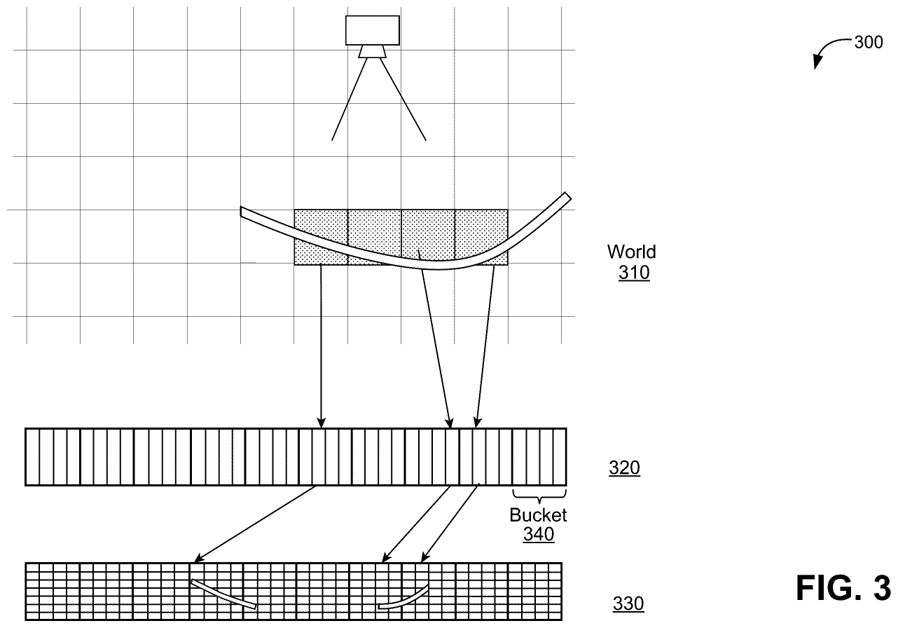

FIG. 3 shows an example of a hash map lookup type of volume block representation. In particular, FIG. 3 is a diagram illustrating an example of a hash mapping function 300 for indexing voxel blocks 330 in a volume grid. In FIG. 3, a volume grid is shown with world coordinates 310. Also shown in FIG. 3 are a hash table 320 and voxel blocks 330. In one or more examples, a hash function can be used to map the integer world coordinates 310 into hash buckets 340 within the hash table 320. The hash buckets 340 can each store a small array of points to regular grid voxel blocks 330. Each voxel block 330 contains data that can be used for depth integration.

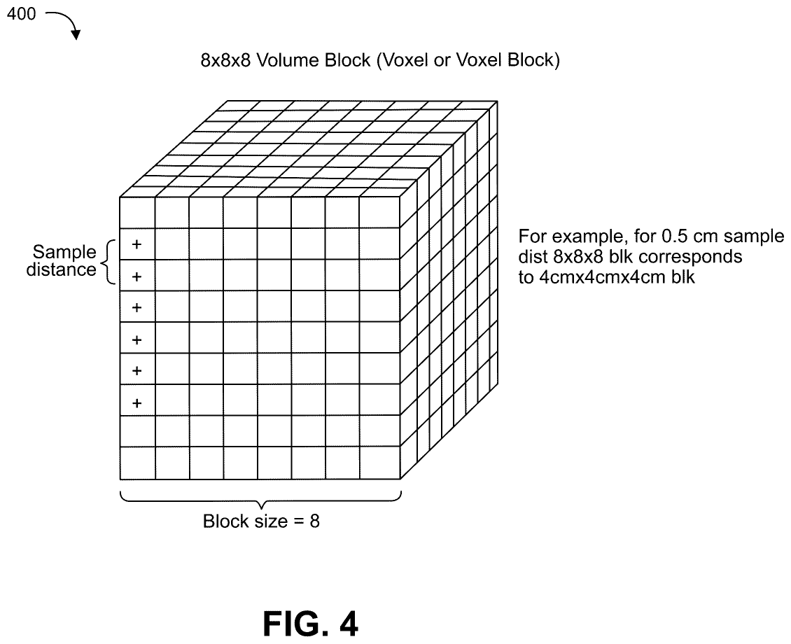

FIG. 4 is a diagram illustrating an example of a volume block (e.g., a voxel block) 400. In FIG. 4, the voxel block 400 is shown to have a block size of eight. For example, a 0.5 centimeter (cm) sample distance for an eight by eight by eight voxel block can correspond to a four cm by four cm by four cm voxel block. That is, the voxel block 400 includes a 3D lattice of 512 voxels, the voxels arranged so that the voxel block 400 has a width of 8 voxels, a length of 8 voxels, and a height of 8 voxels.

In one or more examples, each voxel block (e.g., voxel block 400) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on Equation (1) below:

$$tsdf = \{ \begin{matrix}- 1 & if d \leq - ramp \\ \frac{d}{ramp} , & if - ramp < d < ramp \\ 1 , & if d \geq ramp\end{matrix} \} \qquad Equation ( 1 )$$

$$sample . tsdf = ( \frac{sample . weight * sample . tsdf + tsdf}{sample . weight + 1} )$$

A TSDF integration or fusion process can be employed that updates the TSDF values and weights with each new observation from the sensor (e.g., camera).

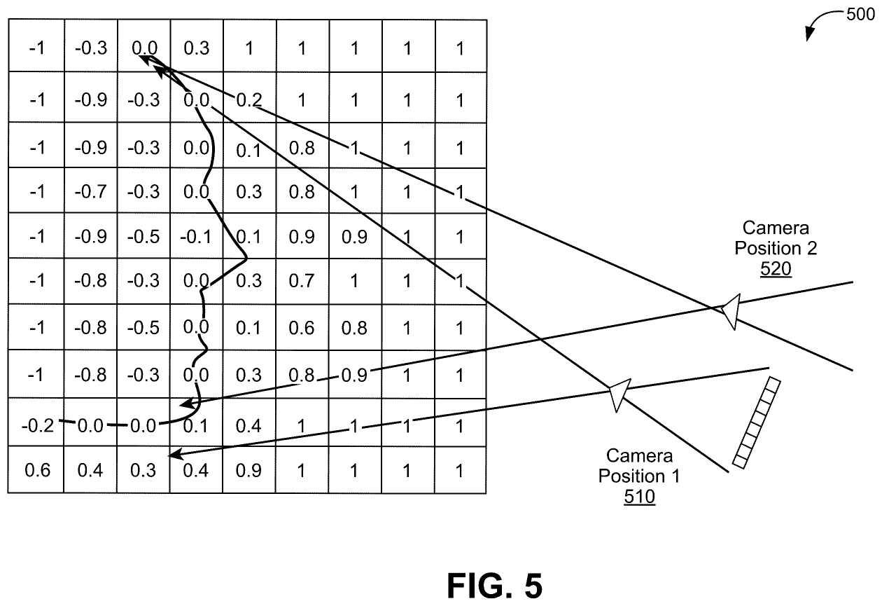

FIG. 5 is a diagram illustrating an example of a TSDF volume reconstruction 500. In FIG. 5, a voxel grid including a plurality of voxel blocks is shown. A camera is shown to be obtaining images of a scene (e.g., person's face) from two different camera positions (e.g., camera position 1 510 and camera position 2 520). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 5, the voxel blocks with positive values are shown to be located in front of the person's face, the voxel blocks with negative values are shown to be located inside of the person's face, and the voxel blocks with zero values are shown to be located on the surface of the person's face.

As previously mentioned, 3DR is a fundamental task to understand the geometry of a 3D scene. 3DR can enable the development of many interesting use cases (e.g., plane detection, obstacle avoidance, occlusion rendering, etc.). In 3DR, 3D surfaces can be represented by a triangular mesh, which includes vertices and faces or triangles. If fine details on surfaces with sharp edges is desired, the resulting triangular mesh may have a large number of vertices and faces (e.g., in the realm of millions). This large number of vertices and faces can be challenging to manage, in particular, for an edge device (e.g., a mobile device, such as a smartphone). For a live 3DR (e.g., a block-based 3DR), where the user incrementally and continuously scans the scene, the management issue can become more significant. To address this issue, mesh simplification has been utilized to ensure that whenever an initial mesh is extracted for a scene (e.g., typically done using a marching cube algorithm), then the mesh can be simplified to have a lower number of vertices and faces to decrease computational load for down-stream tasks.

Currently, in 3DR, there is a need for reducing the size of the mesh to allow for less storage, faster rendering, simpler manipulation, BW savings, and power savings. Therefore, design goals and properties for mesh simplification can include efficiency and producing a good approximation of the scene. A major issue, currently, in block-based mesh simplification is the handling of the block boundaries for mesh consistency. Thus, improved systems and techniques for block-based mesh simplification for 3DR can be useful.

In one or more aspects, the systems and techniques provide block-based mesh simplification. In one or more examples, the systems and techniques provide solutions that follow a divide and conquer approach for mesh simplification. For example, instead of performing an iterative global simplification, a block-based boundary-preserving local mesh simplification can be performed (e.g., as a first step) on meshes extracted from TSDF blocks. The blocks, therefore, can be processed independently in parallel, if parallel processing is feasible. After local processing has been performed, the overlapping boundaries of the neighboring blocks can be merged together to produce a continuous mesh. The unaltered boundary vertices can be (e.g., in a second step) identified, and only the boundary vertices may be simplified among themselves, keeping the internal vertices fixed. The boundary vertices can merge together between themselves and with the internal vertices with which they create triangles, but the internal vertices are not moved (e.g., held fixed).

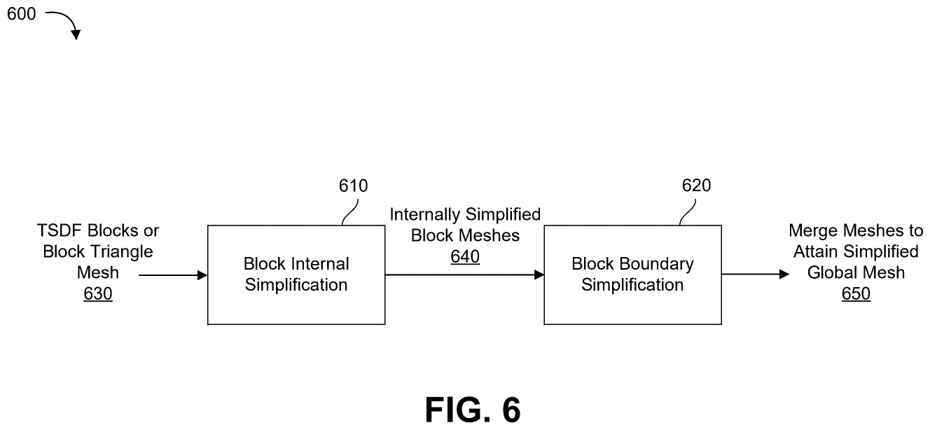

FIG. 6 shows an example process for block-based mesh simplification. In particular, FIG. 6 is a diagram illustrating an example of a process 600 for block-based mesh simplification. In one or more examples, the process 600 includes two steps, which include a block internal simplification 610 (e.g., internal simplification of a block level) and a block boundary simplification 620 (e.g., block level boundary simplification).

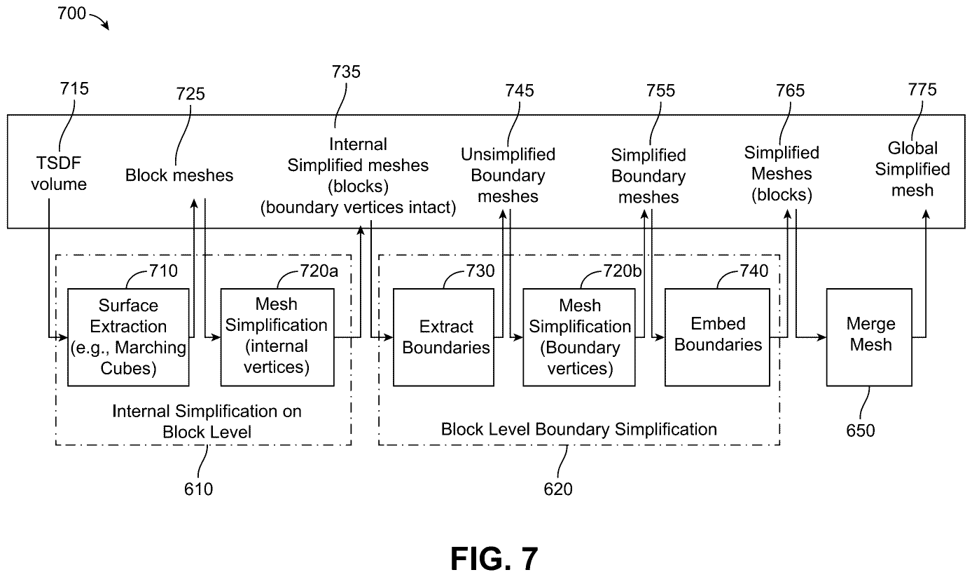

During operation of the process of FIG. 6, one or more processors can generate, based on performing block internal simplification 610 on a plurality of blocks 630 (e.g., TSDF blocks) representing a scene, a respective internally simplified block mesh 640 associated with each block 630 of the plurality of blocks 630. The description of FIG. 7 describes details of the process for the block internal simplification 610.

The one or more processors can generate, based on performing block boundary simplification 620 on the respective internally simplified block meshes 640, a respective simplified mesh associated with each block 630 of the plurality of blocks 630. The description of FIG. 7 describes details of the process for the block boundary simplification 620. The one or more processors can then generate, based on merging 650 the simplified meshes together, a simplified global mesh.

FIG. 7 shows a more detailed example process for block-based mesh simplification. In particular, FIG. 7 is a diagram illustrating an example of a detailed process 700 for block-based mesh simplification. In one or more examples, the process 700 includes two steps, which include internal simplification on a block level (e.g., the block internal simplification 610) and block level boundary simplification (e.g., the block boundary simplification 620).

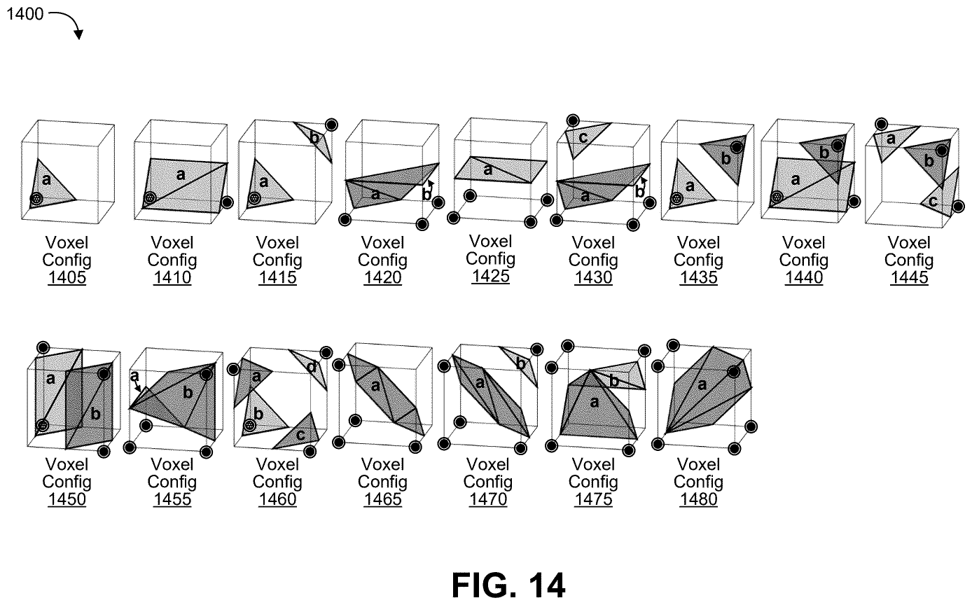

During operation of the process of FIG. 7, one or more processors may perform block internal simplification 610 (e.g., internal simplification on a block level). For the block internal simplification 610, the one or more processors can generate, based on surface extraction 710 of a plurality of blocks 715 (e.g., TSDF volumes) representing a scene, a respective block mesh 725 for each block 715 of the plurality of blocks 715. In one or more examples, the one or more processors can perform the surface extraction 710 based on a marching cubes algorithm. The description of FIG. 14 describes an example of surface extraction using a marching cube algorithm. In one or more examples, each of the block meshes 725 can include a plurality of triangles and vertices. In some examples, the marching cubes algorithm, along with producing the block meshes 725, can produce additional data, including a grid identification (ID) (e.g., a boundary ID) for each vertex. For instance, the grid ID can indicate where the vertex is extracted in a continuous grid. In some cases, the grid ID can be used for combining vertices along the block boundaries. In one or more examples, each block 715 can have a volume (e.g., similar to volume block 400 of FIG. 4), such as a 16×16×16 volume.

After the block meshes 725 have been extracted, for the block internal simplification 610, the one or more processors can generate, based on mesh simplification 720a of each respective block mesh 725, a plurality of internal simplified meshes 735 for the plurality of blocks 715. Each internal simplified mesh 735 of the plurality of internal simplified meshes 735 can be associated with a respective block 715 of the plurality of blocks 715.

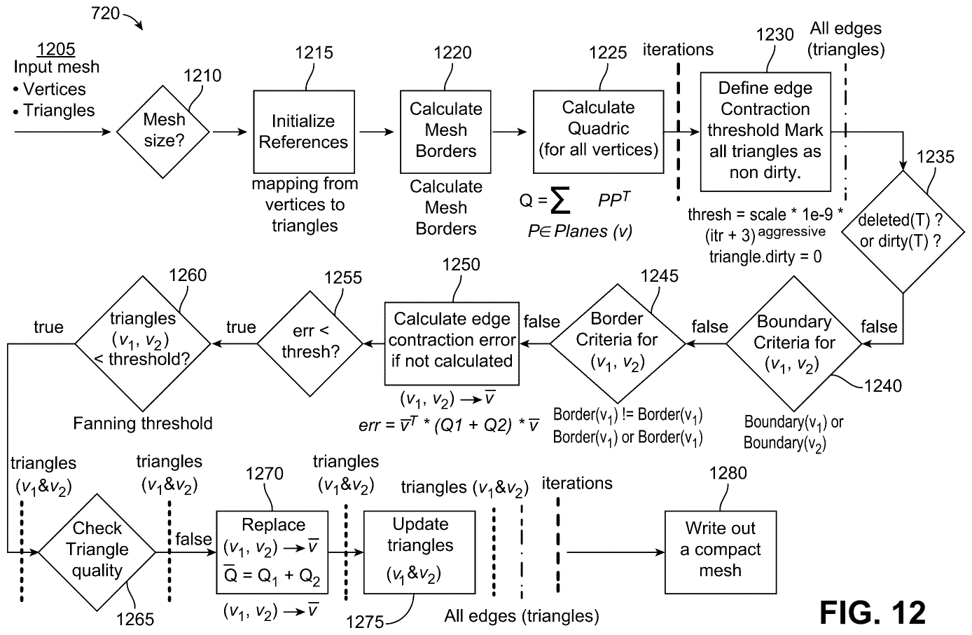

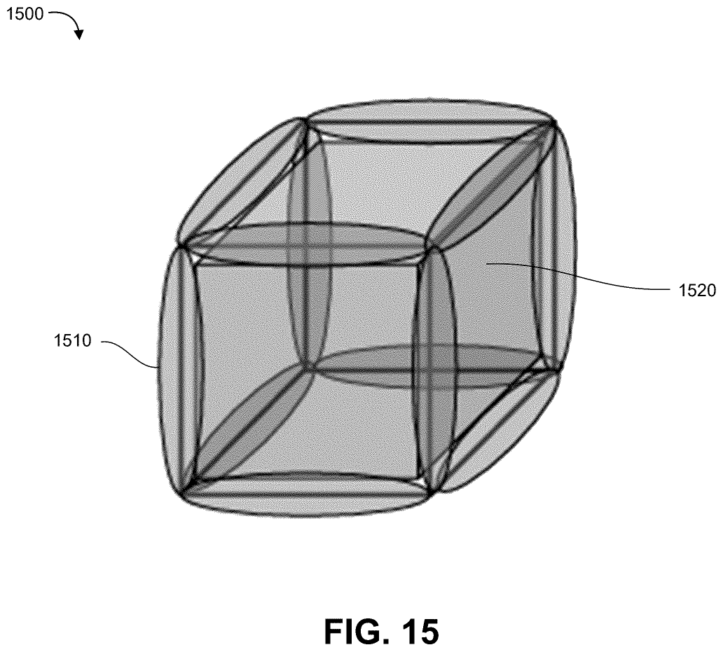

In one or more examples, each block mesh 725 of the respective block meshes 725 can include a plurality of respective vertices and a plurality of respective triangles. In one or more examples, generating the respective internal simplified mesh 735 for each block 715 of the plurality of blocks 715 can be further based on simplifying vertices of the plurality of respective vertices of the respective block meshes 725 located internal of the plurality of blocks 715 (e.g., the vertices located on the inside of the blocks 715 and not on the boundary of the blocks 715). In some examples, simplifying the vertices of the plurality of respective vertices of the respective block meshes 725 located internal of the plurality of blocks 715 can be based on a quadric error measure. For example, the process of mesh simplification 720a can involve iteratively collapsing edges based on a quadric error measure. The mesh simplification 720a can simplify the internal vertices and keep the boundary vertices intact. The description of FIG. 12 describes an example process 720 for the mesh simplification 720a. FIG. 15 shows an example of an internal region 1520 of a block 1500.

After the respective block meshes 725 have been simplified, for the block level boundary simplification 620, the one or more processors can generate, based on extracting boundaries (e.g., extract boundaries 730) of the plurality of internal simplified meshes 735, a plurality of unsimplified boundary meshes 745 for the plurality of blocks 715. Each unsimplified boundary mesh 745 of the plurality of unsimplified boundary meshes 745 can be associated with a respective block 715 of the plurality of blocks 715.

In one or more examples, each internal simplified mesh 735 of the respective internal simplified meshes 735 can include a plurality of respective vertices and a plurality of respective triangles. In some examples, generating the unsimplified boundary mesh 745 associated with a respective block 715 of the plurality of blocks 715 can be further based on merging vertices of the plurality of respective vertices located on boundaries of neighboring blocks (e.g., boundaries between two neighboring blocks) of the plurality of blocks 715. In one or more examples, a neighboring block can be a block that is adjacent to one or more boundaries of a block 715. FIG. 15 shows an example of boundaries 1510 of a block 1500.

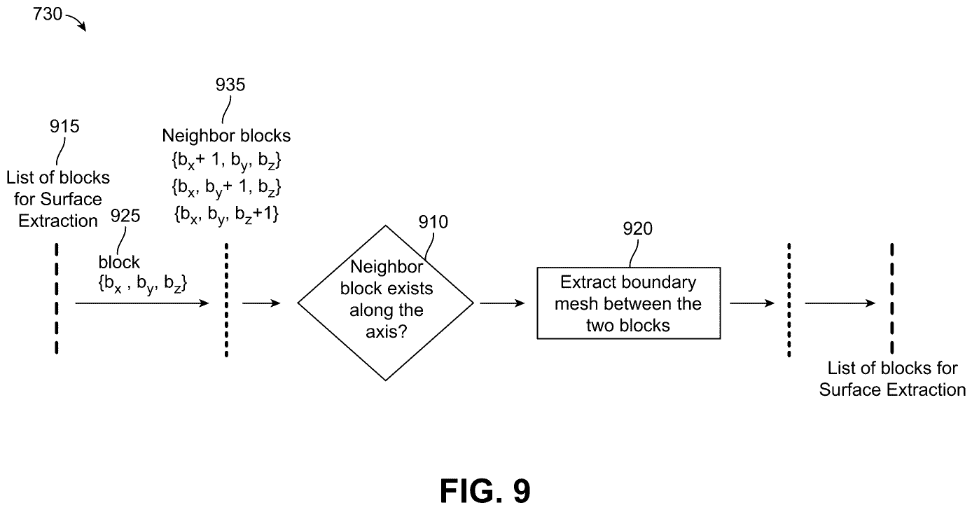

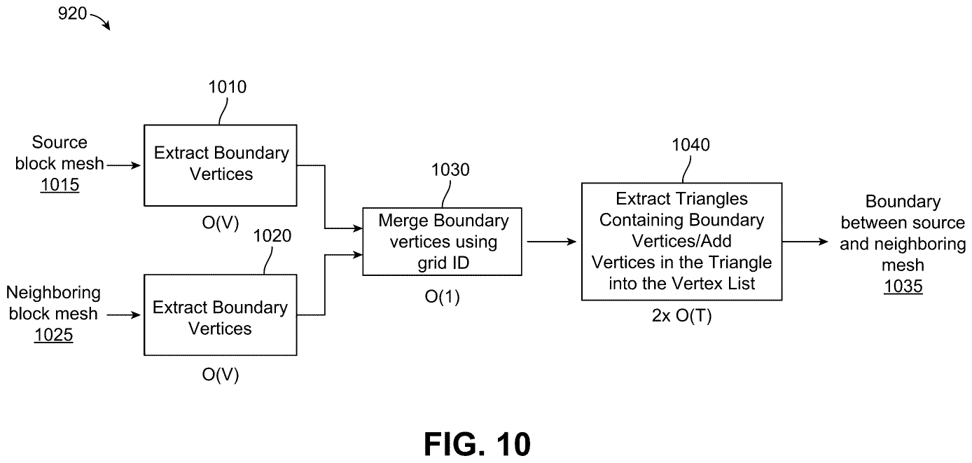

In one or more examples, generating the respective unsimplified boundary mesh 745 associated with a respective block 715 of the plurality of blocks 715 can be further based on extracting triangles of the plurality of respective triangles connected to vertices of the plurality of respective vertices located on boundaries of the plurality of blocks 715. In some examples, generating the respective unsimplified boundary mesh 745 associated with each block 715 of the plurality of blocks 715 can be further based on extracting vertices of the plurality of respective vertices connected to the triangles of the plurality of respective triangles extracted from the respective internal simplified meshes 735. The description of FIGS. 9 and 10 together describe an example process 730, 920 for extracting the boundaries.

After the respective unsimplified boundary meshes 745 have been generated, for the block level boundary simplification 620, the one or more processors can generate, based on mesh simplification 720b of the plurality of unsimplified boundary meshes 745, a plurality of simplified boundary meshes 755. Each simplified boundary mesh 755 of the plurality of simplified boundary meshes 755 can be associated with a respective block 715 of the plurality of blocks.

In one or more examples, each unsimplified boundary mesh 745 of the respective unsimplified boundary meshes 745 can include a plurality of respective vertices and a plurality of respective triangles. In some examples, generating each simplified boundary mesh 755 associated with a respective block 715 of the plurality of blocks 715 can be further based on simplifying vertices of the plurality of respective vertices of a respective unsimplified boundary mesh 745 of the plurality of unsimplified boundary meshes 745 located on boundaries of the plurality of blocks 715. The description of FIG. 12 describes an example process 720 for the mesh simplification 720b.

After the respective unsimplified boundary meshes 745 have been simplified, for the block level boundary simplification 620, the one or more processors can generate, based on embedding simplified boundaries (e.g., embed boundaries 740) of each simplified boundary mesh 755 into a respective internal simplified mesh 735, a plurality of simplified meshes 765. Each simplified mesh 765 of the plurality of simplified meshes 765 can be associated with a respective block 715 of the plurality of blocks 715.

After the simplified boundaries have been embedded, the one or more processors can generate, based on merging the plurality of simplified meshes 765 (e.g., merge mesh 650), a simplified global mesh 775 for the plurality of blocks 715. In one or more examples, the merging of the respective simplified meshes 765 can be based on concatenating the respective simplified meshes 765 together.

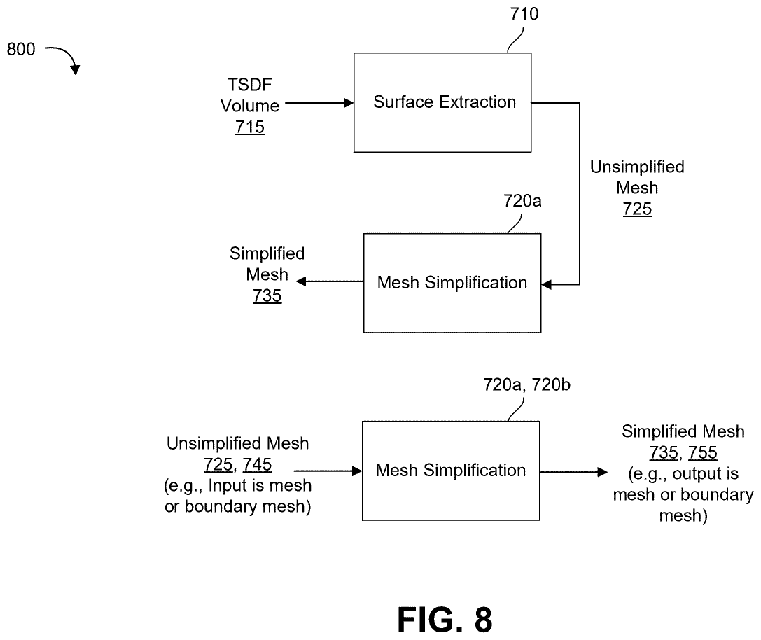

FIG. 8 shows an example hardware flow for block-based mesh simplification. In particular, FIG. 8 is a diagram illustrating an example of a hardware flow 800 for block-based mesh simplification. In one or more examples, the hardware flow 800 can be for a single piece of hardware (e.g., a SOC) that can accommodate two different inputs.

In one or more examples, the hardware flow 800 can involve surface extraction and mesh simplification. As shown in FIG. 8 for the hardware flow 800, one or more processors can generate, based on surface extraction (e.g., extract surface 710) of a plurality of blocks 715 (e.g., TSDF volumes), a respective unsimplified mesh (e.g., a block mesh 725) associated with each block 715 of the plurality of blocks 715. The one or more processors can generate, based on mesh simplification 720a of the respective unsimplified meshes 725, a respective simplified mesh (e.g., an internal simplified mesh 735) associated with each block 715 of the plurality of blocks 715.

In one or more examples, for the hardware flow 800 of FIG. 8, one or more processors can generate, based on mesh simplification 720a, 720b of a plurality of unsimplified meshes (e.g., block meshes 725 or unsimplified boundary meshes 745), a respective simplified mesh (e.g., an internal simplified mesh 735 or a simplified boundary mesh 755) associated with each block 715 of the plurality of blocks 715. In one or more examples, the mesh simplification 720a, 720b can be a simplification of internal vertices to generate internal simplified meshes 735, or can be a simplification of boundary vertices to generate simplified boundary meshes 755.

In one or more aspects, the block-based mesh simplification can support incremental mesh simplification. In one or more examples, a disclosed block mesh (e.g., generated by incremental mesh simplification) can be defined by the following pseudocode:

```
TriangleMesh /Definition of Original Global Mesh/
{
  vector<Vec3f> vertices;
  vector<Vec3I> indices;
  vector<Vec4U> colors;
}
TriangleSubMesh /Definition of Existing Block Mesh/
{
  vector<Vec3f> vertices;
  vector<uint16> vertex_index;
  vector<Vec3I> indices
}
BlockTriangleMesh /Definition of Disclosed Block Mesh/
{
  TriangleMesh unsimplified; /needed when texture/label is enabled/
  TriangleMesh internal_simplified;
  TriangleSubMesh unsimplified_boundaries (6);
  TriangleSubMesh simplified_boundaries (6);
  TriangleMesh simplified;
}
```

This definition of a block mesh supports incremental mesh simplification with some memory overhead. If a neighboring block of a block has an updated mesh, the boundaries from the internal simplified meshes will need to be exacted and the resultant meshes will need to be re-simplified. If any boundary has been updated, all unsimplified simplified boundaries will be needed derive the simplified mesh. With an order of N (O(N)) complexity, at runtime, un-simplified boundaries need to be replaced with simplified boundaries to the internal simplified mesh with O(N) complexity.

FIG. 9 shows an example process for extracting boundaries. In particular, FIG. 9 is a diagram illustrating an example of a process 730 for extracting boundaries in the process 700 of FIG. 7. During operation of the process 730, one or more processors can obtain a list 915 of blocks 925 (e.g., representing a scene) for surface extraction. In one or more examples, each block 925 within the list 915 can have a grid ID {bₓ, b_{y}, b_{z}}. As noted previously, the grid ID can indicate where the vertex is extracted in a continuous grid. The grid ID can be used for combining vertices along the block boundaries. For example, the one or more processors, based on the grid IDs of the blocks 925 within the list 915, can determine the neighboring blocks 935 (e.g., adjacent blocks) to the blocks 925. In one or more examples, three neighboring blocks 935 may have a grid ID of {bₓ+1, b_{y}, b_{z}}, {bₓ, b_{y}+1, b_{z}}, and {bₓ, b_{y}, b_{z}+1}, respectively.

The one or more processors can then determine whether a neighboring block 935 exists along an axis 910 (e.g., x-axis, y-axis, or z-axis) in a positive direction with respect to a block 925 in the list of blocks. If the one or more processors determines that a neighboring block 935 does exist along an axis 910 (e.g., x-axis, y-axis, or z-axis) in a positive direction with respect to the block 925, the one or more processors can extract a boundary mesh between these two blocks 920 (e.g., the neighboring block 935 and the block 925). The description of FIG. 10 describes an example process 920 for extracting a boundary mesh between these two blocks.

FIG. 10 shows an example process for extracting a boundary mesh between a block and its neighboring block. In particular, FIG. 10 is a diagram illustrating an example of a process 920 for extracting a boundary mesh between two blocks (e.g., block 925 and neighboring block 935) in the process 730 of FIG. 9. During operation of the process 920, one or more processors can extract 1010, from a source block mesh 1015 (e.g., a mesh associated with the block 925), boundary vertices (e.g., source block boundary vertices) that are located adjacent to the neighboring block 935. The one or more processors can extract 1020, from a neighboring block mesh 1025 (e.g., a mesh associated with the neighboring block 935), boundary vertices (e.g., neighboring block boundary vertices) that are located adjacent to the block 925 (e.g., a source block).

In one or more examples, the order (O) of each of the extractions 1010, 1020 can be the number of vertices (e.g., O(V)), where V is the number of vertices (e.g., approximately 400 vertices). In some examples, the number of triangles (T) can be equal to approximately 750. In one or more examples, the number of boundaries can be equal to approximately 2500.

After the source block boundary vertices and the neighboring block boundary vertices have been extracted, the one or more processors can then, based on the grid IDs of the block 925 and the neighboring block 935, merge 1030 (e.g., by matching a pair of sixteen values) the source block boundary vertices and the neighboring block boundary vertices that lie between the block 925 and the neighboring block 935. The one or more processors can then generate, by extracting 1040 triangles containing these merged boundary vertices and adding vertices in the triangles into the vertex list, an unsimplified boundary mesh 1035 between the block 925 (e.g., the source block) and the neighboring block 935. In one or more examples, each of the extracting 1040 can have two times the order of the number of the triangles (e.g., 2×O(T)).

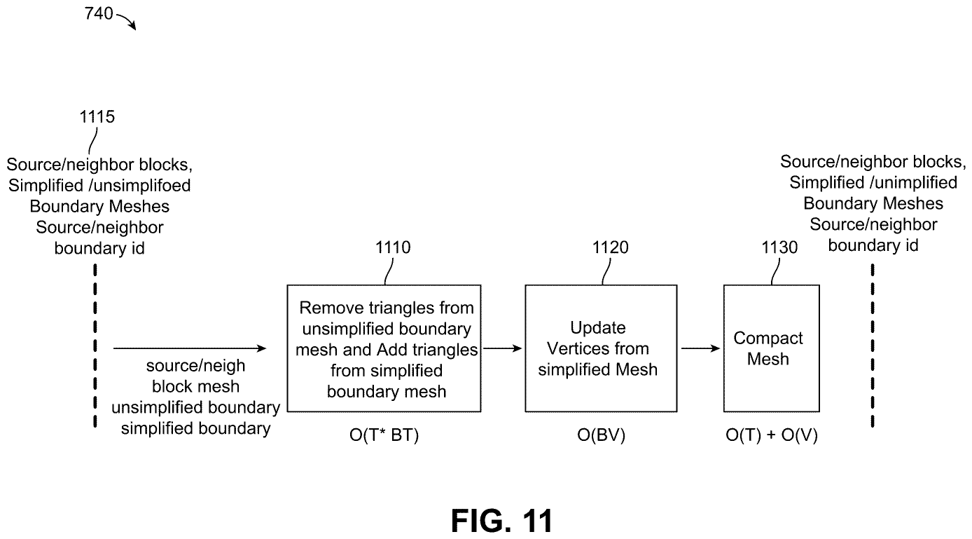

FIG. 11 shows an example process for embedding boundaries. In particular, FIG. 11 is a diagram illustrating an example of a process 740 for embedding boundaries in the process 700 of FIG. 7. During operation of the process 740, one or more processors can obtain 1115 a source block, a neighboring block, a simplified boundary mesh, an unsimplified boundary mesh, a source boundary ID, and a neighboring boundary ID. The one or more processors can remove 1110 triangles from the unsimplified boundary mesh, and add triangles to the simplified boundary mesh. The one or more processors can then update 1120 vertices from the simplified mesh to generate a compact mesh 1130.

In one or more examples, the removing of triangles from the unsimplified boundary mesh and adding of triangles to the simplified boundary mesh can have an order (O) equal to the number of triangles (T) multiplied by the number of boundary triangles (BT). In some examples, the updating of the vertices can have an order (O) equal to the number of boundary vertices (BV). In one or more examples, the compact mesh 1130 can have an order of the number of triangles (T) added to the order of the number of vertices (V).

FIG. 12 shows an example process for mesh simplification. In particular, FIG. 12 is a diagram illustrating an example of a process 720 for mesh simplification in the process 700 of FIG. 7. During operation of the process 720, one or more processors can read one input mesh 1205 at a time. The one or more processors can determine, based on an input mesh 1205, the size 1210 of the input mesh 1205. The one or more processors can determine, based on the size of the input mesh 1205, whether the mesh 1205 can be loaded into memory or a cache (e.g., an internal cache). If the one or more processors determine that the size of the mesh 1205 is such that the mesh 1205 can be loaded into memory or a cache, then the mesh simplification can proceed. However, if the one or more processors determine that the size of the mesh 1205 is too large to be loaded into memory or a cache, then the mesh simplification process does not continue to occur.

After the one or more processors have determined that the mesh 1205 can be loaded into memory or a cache, the one or more processors can initialize references 1215 for the mesh 1205 (e.g., by mapping from vertices to triangles). The one or more processors can maintain a listing of the references (e.g., including the mappings of the vertices to the triangles). The one or more processors can then calculate, based on the mesh 1205, mesh borders 1220 (e.g., which are not the same as boundaries). The one or more processors can then calculate, a quadric error metric (Q) 1225 for every vertex over all of the planes (P), which are triangles. The quadric error metric is a four by four symmetric matrix.

The one or more processors can then define an edge contraction threshold for every iteration, and can mark all of the triangles as non-dirty 1230. The one or more processors can then determine (at block 1235) whether each triangle (T) is marked dirty or is deleted. If the one or more processors determine that a triangle is not (false) marked dirty or is deleted, the one or more processors can determine whether the triangle, based on boundary criteria for boundary vertices (v₁, v₂) of blocks, is located on a boundary 1240 of a block.

If the one or more processors determines that the triangle is not located (false) on a boundary of a block, the one or more processors can proceed to determine whether the triangle, based on border criteria for border vertices (v₁, v₂) of blocks, is located on a border 1245. If the one or more processors determines that the triangle is not located (false) on a border of a block, the one or more processors can calculate an edge contraction error 1250, if the error has not already been calculated. The edge contraction error is based on whether an error occurs when an edge is collapsed.

The one or more processors can then determine 1255 whether the calculated edge contraction error (err) is less than an edge contraction error threshold (thresh). If the one or more processors determines that the calculated edge contraction error is less (true) than an edge contraction error threshold, the one or more processors can proceed to determine 1260 whether a span of the triangles is less than a spanning threshold (e.g., to limit the number of triangles connected to a single vertex). The spanning threshold can be used to monitor the simplification quality. If the one or more processors determines that the span of the triangles is less (true) than a spanning threshold, the one or more processors can check the triangle quality 1265 for resulting artifacts (e.g., to determine if any artifacts exist when removing triangles and merging vertices together).

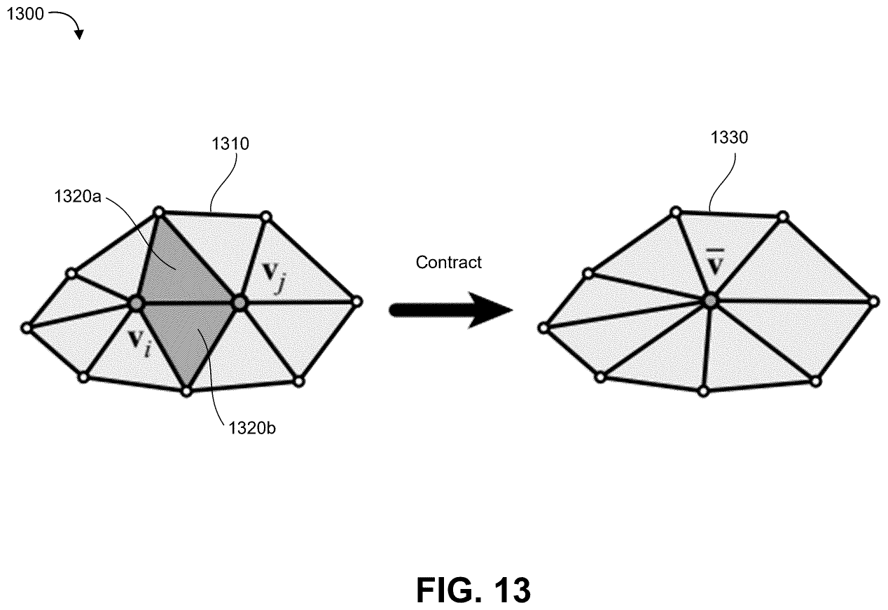

If the one or more processors determine that the triangle quality does not (false) have resulting artifacts, the one or more processors can merge the vertices (v₁, v₂) together into a single vertex (v) at block 1270, such as illustrated in FIG. 13. The one or more processors can then proceed to go through the entire list of triangles, and update the triangles 1275 accordingly. After the triangles have been updated, a single iteration of the process 720 is complete. The one or more processors can proceed to repeat the process 720 for a number of iterations. With each iteration, more vertices and triangles are deleted. After the iterations have been completed, the one or more processors can write out a compact mesh 1280 including the remaining triangles and vertices.

FIG. 13 illustrates an example of mesh simplification. In particular, FIG. 13 is a diagram illustrating an example of mesh simplification 1300. In FIG. 13, an initial mesh 1310 (e.g., before mesh simplification) and a resultant mesh 1330 (e.g., post mesh simplification) are shown. As shown in FIG. 13, for the mesh simplification 1300, one or more processors can remove triangles 1320a, 1320b that are shared by two vertices (e.g., vᵢ and vⱼ) within the initial mesh 1310. The one or more processors can then generate, by merging the two vertices (e.g., vᵢ and vⱼ) together to form a single vertex (e.g., v), the resultant mesh 1330.

FIG. 14 shows an example of surface extraction using a marching cube algorithm. In particular, FIG. 14 is a conceptual diagram 1400 illustrating representations of surface extraction and mesh generation at a voxel level. Using the marching cube algorithm, surface extraction (e.g., surface extraction 710 of FIG. 7) can be performed one voxel at a time. Each voxel is a cube having eight corners. The eight vertices 1410 of the polygon 1405 (e.g., cube) A, B, C, D, E, F, G, and H of FIG. 14 are examples of the eight corners of a voxel. Each of the eight corners is a point having its own TSDF value. The TSDF value for a point may be positive, negative, or zero. Based on whether the TSDF values for the corners of the voxel are positive, negative, or zero, the corresponding surface(s) that best fit that particular voxel may change. Assuming the TSDF value for each corner is either positive or negative, a given voxel can have 28=256 different surface configurations.

If all of the corners of the voxel have positive TSDF values, this indicates that the entirety of the voxel is outside of the surface, so no surface intersects with that voxel. Similarly, all of the corners of the voxel have negative TSDF values, this indicates that the entirety of the voxel is inside of the surface, so again, no surface intersects with that voxel. Thus, those two voxel configurations represent voxels with no surfaces in them. This leaves 256−2=254 configurations of voxels for which a surface intersects with the voxel. Depending on which corners are positive or negative, these 254 voxel configurations can be represented by 16 different voxel configurations, including voxel configuration 1405, voxel configuration 1410, voxel configuration 1415, voxel configuration 1420, voxel configuration 1425, voxel configuration 1430, voxel configuration 1435, voxel configuration 1440, voxel configuration 1445, voxel configuration 1450, voxel configuration 1455, voxel configuration 1460, voxel configuration 1465, voxel configuration 1470, voxel configuration 1475, and the voxel configuration 1480.

These 16 different voxel configurations may be rotated depending on which corners have positive TSDF values versus which corners have negative TSDF values. One or more processors, when performing surface extraction (e.g., surface extraction 710 of FIG. 7), can compute the zero crossings along the edges of the voxels based on the TSDF values of the corners. For instance, if a first corner have a positive TSDF value and a second corner has a negative TSDF value, then a zero crossing of the surface (e.g., the point at which the TSDF value is zero) occurs somewhere along the edge of the voxel between the first corner and the second corner. The zero crossing can be estimated differently depending on the respective magnitudes (e.g., absolute values) of the TSDF values of the two corners, for instance so that the zero crossing is closer to whichever corner has the lower magnitude (e.g., absolute value) of its TSDF value. The zero crossing location along the edge of the voxel indicates where a given surface intersects with the voxel.

The voxel configurations 1405-1480 are illustrated in FIG. 14 with certain corners of the voxel being represented by large dark dots with circles around them (referred to as “circled dots” below), and other corners lacking the circled dots. The dots (within the circled dots) are illustrated as black where unoccluded by surfaces, or shaded with a halftone pattern where occluded by surfaces. The corners represented by the large-circled dots have TSDF values with a different sign than the TSDF values of the corners that lack the circled dots. For instance, in a first illustrative example, the corners illustrated with circled dots have negative TSDF values, while the corners that lack the circled dots have positive TSDF values. In a second illustrative example, the corners illustrated with circled dots have positive TSDF values, while the corners that lack the circled dots have negative TSDF values. The surface(s) that intersect with a given voxel are illustrated as translucent grey surfaces, with each surface made up of one or more triangles. In situations where a voxel has two or more intersecting surfaces that are close to one another and/or overlap from the perspective illustrated in FIG. 14, the surfaces intersecting the voxel (and that are close to one another) are shaded using two different shades of grey (one lighter and one darker) to help distinguish the different surfaces. Furthermore, the surfaces intersecting the voxel are labeled with letters (e.g., a, b, c, d, and so forth). Voxels with only one intersecting surface are illustrated with that surface labeled “a”; voxels with two intersecting surfaces are illustrated with those surface labeled “a” and “b,” respectively; voxels with three intersecting surfaces are illustrated with those surface labeled “a,” “b,” and “c” respectively; and so forth. In some examples, a given voxel configuration can look the same if the respective TSDF values of all of the corners flip signs. For instance, the position of the surface intersecting the voxel configuration 1405 can be the same regardless of whether (a) the corner with the circled dot has a negative TSDF value and the other corners without the circled dots have positive TSDF values, or (b) the corner with the circled dot has a positive TSDF value and the other corners without the circled dots have negative TSDF values.

As previously mentioned, mesh simplification has been employed to ensure that whenever an initial mesh is extracted for a scene, then the mesh is simplified to have a lower number of vertices and faces to lighten the load for down-stream applications. Depending upon the availability of the resources or the nature of the downstream task, a user might need different levels of a mesh simplification ratio (e.g., which is the size of the initial mesh/the size of the simplified mesh). Doing this for a global mesh that is already extracted for the entire scene and when there is no resource limitations (e.g., such as memory or cache size) is easy to achieve and enforceable because mesh simplification is an iterative process. Since mesh simplification is an iterative process, it is possible to keep track of the remaining vertices and faces in the simplified mesh during each iteration and, thus, stop the mesh simplification process whenever the target mesh simplification ratio is achieved. However, simplifying a mesh that is being built in real-time and in a block-by-block manner, or when due to resource constraints, a global mesh is broken down into smaller pieces and then each piece is simplified independently, is not as trivial when there is a desired simplification ratio. To this end, the systems and techniques provide a framework that can achieve the desired simplification ratio (e.g., a simplification rate control) for a block-based 3D mesh extraction approach that is also suitable for a multi-stage simplification rate control framework.

Simplifying a mesh that is extracted in a block-by-block manner can be challenging as it is paramount that all of the blocks' meshes, when merged together, form a single continuous global mesh. Additionally, the simplification is directly proportional to the content that occupies a block. For instance, a complicated geometry inside of a block cannot be highly simplified, while a flat surface inside a block can have high simplification ratios. As such, it is important to ensure that the desired simplification ratio is achieved on an average basis.

In one or more aspects, block-based simplification algorithms can perform simplification in multiple stages. For instance, block-based simplification algorithms may first simplify the internal content of a block that is connected to the outside of the block by at least one intermediary vertex on the block's boundary. The unsimplified mesh at the shared border of two neighboring blocks can then be simplified, which can ensure the continuity of the simplified mesh across blocks. This process can be extended to more than two stages, depending upon the procedure of the simplifying algorithm. Based on this, the rate control mechanism, upon the requested simplification rate from a user (rₐₛₖ), can compute the expected simplification rate at each individual stage (r₁ . . . rₙ, n: #stages) such that, on average, the overall simplification rate (r_{achieved}) is close to the requested rate (rₐₛₖ). For example, in some aspects, the simplification rate r can be defined as follows:

$${r}_{achieved} = {r}_{1} * {r}_{2} … * {r}_{n} \approx {r}_{ask}$$

$$r = \frac{\# of triangles in the initial block mesh}{\# of triangles in the simplified block mesh} = {r}_{1} * {r}_{2} … * {r}_{n} = {{\prod }_{j = 1}}^{n} \frac{{t}^{j - 1}}{{t}^{j}}$$

$${t}^{0} : \# of trianges in the initial mesh$$

In one or more aspects, there are a number of technical advantages for this framework for achieving the desired simplification ratio (e.g., a rate control) for a block-based 3D mesh extraction approach. For example, currently, there are no rate control mechanisms for block-based 3D mesh simplification algorithms that can accommodate real-time and simultaneous mesh extraction, and simplification at a desired rate. The systems and techniques provide an approach that can realize an adjustable simplification rate that depends upon resource availability and an end-application, especially on an edge device (e.g., a mobile device). The approach is a generic and data centric approach that can facilitate diverse simplification strategies in terms of the number of steps, and the maximum simplification capabilities.

In one or more aspects, the systems and techniques provide a block-based mesh simplification rate control. In one or more examples, it can be assumed that the simplification of a block is performed in two steps. However, the block-based mesh simplification rate control can be generalized to the simplification algorithms with more than two steps as well.

In one or more examples, the simplification rate can be defined as the following:

$$r = \frac{\begin{matrix}\# of triangles ( internal and boundary ) \\ in the initial block mesh\end{matrix}}{\begin{matrix}\# of triangles ( internal and boundary ) \\ in the simplified block mesh\end{matrix}} = \frac{{t}_{i} + {t}_{b}}{{t}_{{S}_{i}} + {t}_{{S}_{b}}}$$

$${t}_{i} : internal triangles$$

$${t}_{{S}_{i}} : simplified internal triangles$$

$${t}_{b} : boundary triangles$$

$${t}_{{S}_{b}} : simplified boundary triangles$$

Assuming that the first stage simplifies the internal mesh and the second stage simplifies the mesh at the shared boundary of a block with its neighbors, then the simplification rates for each of the stages can be defined as:

$${r}_{1} = \frac{{t}_{i} + {t}_{b}}{{t}_{{S}_{i}} + {t}_{b}} , {r}_{2} = \frac{{t}_{{S}_{i}} + {t}_{b}}{{t}_{{S}_{i}} + {t}_{{S}_{b}}} , r = {r}_{1} \cdot {r}_{2}$$

Depending upon the nature of the simplification algorithm, some assumptions on each of the stage's simplification can be made. For instance, it can be assumed that:

$$\frac{{t}_{i}}{{t}_{{S}_{i}}} = \frac{{t}_{b}}{{t}_{{S}_{b}}}$$

This assumption results in:

$$r = \frac{{t}_{i}}{{t}_{{S}_{i}}} = \frac{{t}_{b}}{{t}_{{S}_{b}}}$$

Each of the stage's rates can then be computed such that their multiplication equals the requested rate rₐₛₖ, where:

$${r}_{{1}_{a s k}} = {r}_{a s k} \cdot \frac{\overline{{t}_{ι}} + \overline{{t}_{b}}}{\overline{{t}_{ι}} + {r}_{a s k} \cdot \overline{{t}_{b}}} , {r}_{{2}_{a s k}} = \frac{\overline{{t}_{ι}} + {r}_{ask} \cdot \overline{{t}_{b}}}{\overline{{t}_{ι}} + \overline{{t}_{b}}}$$

Here, it has been assumed that the average block has t̅ᵢ̅ internal triangles and t̅_̅{̅b̅}̅ boundary triangles. The complexity of the assumptions can be increased to make each stage's rate more adaptive based on the geometry of the mesh inside the block. However, any extra assumption or side information can increase the complexity of the rate control mechanism, which can be limiting in a resource constraint environment.

In one or more examples, when prior information on the content of a block (e.g., whether the block represents a planar versus a non-planar surface) is available, then the rate control can take this information into account and allow for the mesh simplification run further on planar surfaces to achieve a higher compression ratio than the prescribed rate since blocks with a complex geometry do not simplify as much and fall short from the prescribed rate. As such, this rate control mechanism can closely track the requested rate. In one or more examples, for a multi-stage simplification algorithm, the rate control mechanism can consider a feedback loop per block such that in case the prior stages achieve a higher realized compression than expected, then the subsequent stage's target compression ration can be lowered and vice versa.

FIG. 15 shows an example of parts of a block. In particular, FIG. 15 is a diagram illustrating an example showing parts of a block 1500. In FIG. 15, the internal region 1520 and the boundaries 1510 of the block 1500 are shown.

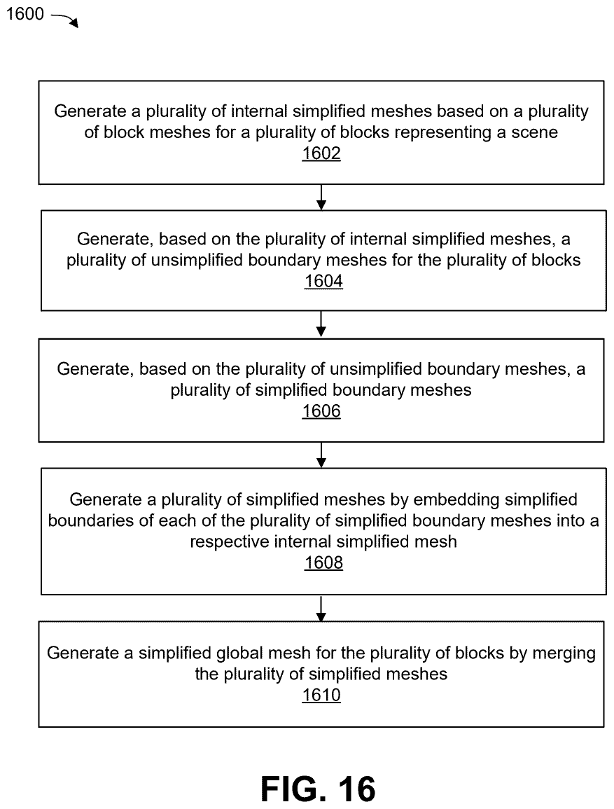

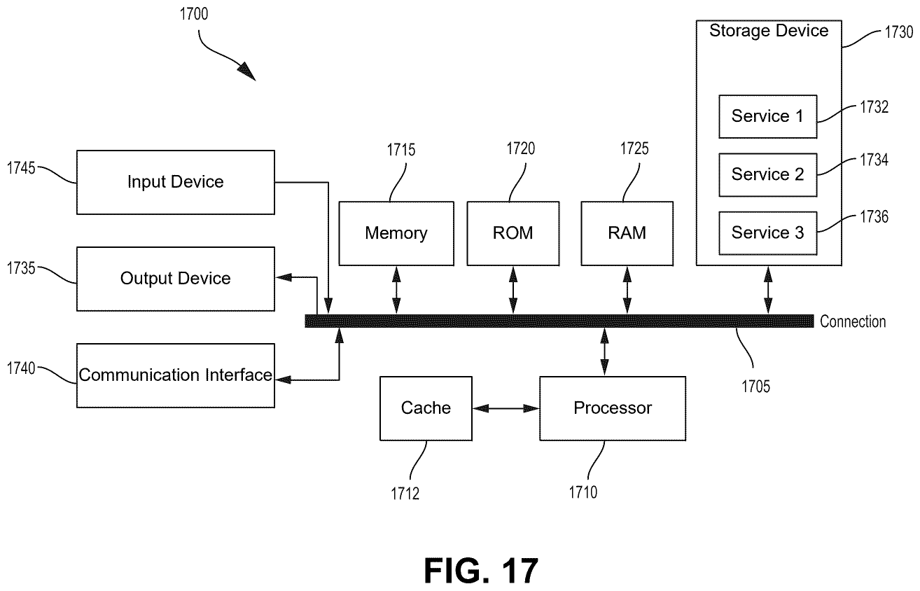

FIG. 16 is a flow chart illustrating an example of a process 1600 for block-based mesh simplification. The process 1600 can be performed by a computing device (e.g., a computing device or computing system 1700 of FIG. 17) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1600 may be implemented as software components that are executed and run on one or more processors (e.g., processor 1710 of FIG. 17, or other processor(s)). Further, the transmission and reception of signals by the computing device in the process 1600 may be enabled, for example, by one or more antennas and/or one or more transceivers (e.g., wireless transceiver(s)).

At block 1602, the computing device (or component thereof) can generate a plurality of internal simplified meshes (e.g., as described with respect to FIG. 6, FIG. 7, etc.) based on a plurality of block meshes for a plurality of blocks representing a scene. For instance, the mesh simplification 720a of FIG. 7 can be performed to generate the plurality of internal simplified meshes (e.g., internal simplified meshes 735). In some aspects, the computing device (or component thereof) can generate the plurality of block meshes by performing surface extraction (e.g., at block 710 of FIG. 7, etc.) of the plurality of blocks. In some cases, the surface extraction is based on a marching cubes algorithm (e.g., the marching cubes algorithm described with respect to FIG. 14). In some cases, each of the plurality of internal simplified meshes is associated with a respective block of the plurality of blocks. In some aspects, each block of the plurality of blocks is a truncated signed distance function (TSDF) volume.

As described herein, in some aspects, each block mesh of the plurality of block meshes includes a plurality of respective vertices and a plurality of respective triangles for a block (e.g., a first block mesh of the plurality of block meshes can include a first plurality of vertices and a first plurality of triangles for a first block, a second block mesh of the plurality of block meshes can include a second plurality of vertices and a second plurality of triangles for a second block, etc.). In some cases, to generate the plurality of internal simplified meshes, the computing device (or component thereof) can generate an internal simplified mesh for a particular block based on simplifying vertices of the plurality of vertices (for the block) located internal of the plurality of blocks. In some examples, the computing device (or component thereof) can simplify the vertices of the plurality of vertices located internal of the plurality of blocks based on a quadric error measure.

At block 1604, the computing device (or component thereof) can generate (e.g., at block 730 of FIG. 7, etc.), based on the plurality of internal simplified meshes, a plurality of unsimplified boundary meshes (e.g., unsimplified boundary meshes 745) for the plurality of blocks. In some cases, each of the plurality of unsimplified boundary meshes is associated with a respective block of the plurality of blocks.

As described herein, in some aspects, each internal simplified mesh of the plurality of internal simplified meshes includes a plurality of respective vertices and a plurality of respective triangles (e.g., a first internal simplified mesh of the plurality of internal simplified meshes includes a first plurality of vertices and a first plurality of triangles, a second internal simplified mesh of the plurality of internal simplified meshes includes a second plurality of vertices and a second plurality of triangles, etc.). In some cases, to generate the plurality of unsimplified boundary meshes, the computing device (or component thereof) can generate an unsimplified boundary mesh associated with a block of the plurality of blocks based on merging vertices of the plurality of vertices located on boundaries of neighboring blocks of the plurality of blocks. In some aspects, the computing device (or component thereof) can generate the unsimplified boundary mesh further based on extracting triangles of the plurality of triangles connected to vertices of the plurality of vertices located on boundaries of the plurality of blocks. Additionally or alternatively, in some examples, the computing device (or component thereof) can generate the unsimplified boundary mesh further based on extracting vertices of the plurality of vertices connected to the triangles of the plurality of triangles extracted from a corresponding internal simplified mesh of the plurality of internal simplified meshes.

At block 1606, the computing device (or component thereof) can generate (e.g., at block 720b of FIG. 7, etc.), based on the plurality of unsimplified boundary meshes, a plurality of simplified boundary meshes (e.g., simplified boundary meshes 755 of FIG. 7). In some cases, each of the plurality of simplified boundary meshes is associated with a respective block of the plurality of blocks.

In some aspects, each unsimplified boundary mesh of the plurality of unsimplified boundary meshes includes a plurality of respective vertices and a plurality of respective triangles (e.g., a first unsimplified boundary mesh of the plurality of unsimplified boundary meshes includes a first plurality of vertices and a first plurality of triangles, a second unsimplified boundary mesh of the plurality of unsimplified boundary meshes includes a second plurality of vertices and a second plurality of triangles, etc.). In some cases, to generate the plurality of simplified boundary meshes, the computing device (or component thereof) can generate a simplified boundary mesh associated with a block of the plurality of blocks based on simplifying vertices of the plurality of vertices located on boundaries of the plurality of blocks.

At block 1608, the computing device (or component thereof) can generate (e.g., at block 740 of FIG. 7, etc.) a plurality of simplified meshes (e.g., simplified meshes 755 of FIG. 7) by embedding simplified boundaries of each of the plurality of simplified boundary meshes into a respective internal simplified mesh. In some cases, each of the plurality of simplified meshes is associated with a respective block of the plurality of blocks.

At block 1610, the computing device (or component thereof) can generate a simplified global mesh, also referred as a global simplified mesh (e.g., global simplified mesh 775) for the plurality of blocks by merging the plurality of simplified meshes (e.g., at block 650 of FIG. 6, FIG. 7, etc.).

In some aspects, the computing device (or component thereof) can determine a simplification rate. The computing device (or component thereof) can generate the plurality of internal simplified meshes based on the determined simplification rate. In some cases, the simplification rate is based on a number of triangles in a block mesh and a number of triangles in a simplified block mesh generated based on the block mesh. For instance, as previously described, the simplification rate can be defined as the following:

$$r = \frac{\begin{matrix}\# of triangles ( internal and boundary ) \\ in the initial block mesh\end{matrix}}{\begin{matrix}\# of triangles ( internal and boundary ) \\ in the simplified block mesh\end{matrix}} = \frac{{t}_{i} + {t}_{b}}{{t}_{{S}_{i}} + {t}_{{S}_{b}}}$$

$${t}_{i} : internal triangles$$

$${t}_{{S}_{i}} : simplified internal triangles$$

$${t}_{b} : boundary triangles$$

$${t}_{{S}_{b}} : simplified boundary triangles$$

In some examples, the simplification rate is based on a first simplification rate (e.g., the simplification rate r₁ described herein) associated with the plurality of internal simplified meshes and a second simplification rate (e.g., the simplification rate r₂ described herein) associated with the plurality of unsimplified boundary meshes. For instance, as previously described, assuming that a first stage simplifies the internal mesh and a second stage simplifies the mesh at the shared boundary of a block with its neighbors, then the simplification rates for each of the stages can be defined as:

$${r}_{1} = \frac{{t}_{i} + {t}_{b}}{{t}_{{S}_{i}} + {t}_{b}} , {r}_{2} = \frac{{t}_{{S}_{i}} + {t}_{b}}{{t}_{{S}_{i}} + {t}_{{S}_{b}}} , r = {r}_{1} \cdot {r}_{2}$$

Each of the stage's rates can be computed such that their multiplication equals the requested rate rₐₛₖ, where:

$${r}_{{1}_{a s k}} = {r}_{a s k} \cdot \frac{\overline{{t}_{ι}} + \overline{{t}_{b}}}{\overline{{t}_{ι}} + {r}_{a s k} \cdot \overline{{t}_{b}}} , {r}_{{2}_{a s k}} = \frac{\overline{{t}_{ι}} + {r}_{ask} \cdot \overline{{t}_{b}}}{\overline{{t}_{ι}} + \overline{{t}_{b}}}$$

In some cases, the computing device of process 1600 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1600 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1600 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 17 is a block diagram illustrating an example of a computing system 1700, which may be employed for block-based mesh simplification. In particular, FIG. 17 illustrates an example of computing system 1700, which can be for example any computing device making up internal computing system, a remote computing system, a camera, or any component thereof in which the components of the system are in communication with each other using connection 1705. Connection 1705 can be a physical connection using a bus, or a direct connection into processor 1710, such as in a chipset architecture. Connection 1705 can also be a virtual connection, networked connection, or logical connection.

In some aspects, computing system 1700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1700 includes at least one processing unit (CPU or processor) 1710 and connection 1705 that communicatively couples various system components including system memory 1715, such as read-only memory (ROM) 1720 and random access memory (RAM) 1725 to processor 1710. Computing system 1700 can include a cache 1712 of high-speed memory connected directly with, in close proximity to, or integrated as part of processor 1710.

Processor 1710 can include any general purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms. In some instances, multimodal systems can enable a user to provide multiple types of input/output to communicate with computing system 1700.

Computing system 1700 can include communications interface 1740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1740 may also include one or more range sensors (e.g., LiDAR sensors, laser range finders, RF radars, ultrasonic sensors, and infrared (IR) sensors) configured to collect data and provide measurements to processor 1710, whereby processor 1710 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1740 may also include one or more receivers or transceivers that are used to determine a location of the computing system 1700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1730 can include software services, servers, services, etc., that when the code that defines such software is executed by the processor 1710, it causes the system to perform a function. In some aspects, a hardware service that performs a particular function can include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: generate a plurality of internal simplified meshes based on a plurality of block meshes for a plurality of blocks representing a scene, wherein each of the plurality of internal simplified meshes is associated with a respective block of the plurality of blocks; generate, based on the plurality of internal simplified meshes, a plurality of unsimplified boundary meshes for the plurality of blocks, wherein each of the plurality of unsimplified boundary meshes is associated with a respective block of the plurality of blocks; generate, based on the plurality of unsimplified boundary meshes, a plurality of simplified boundary meshes, wherein each of the plurality of simplified boundary meshes is associated with a respective block of the plurality of blocks; generate a plurality of simplified meshes by embedding simplified boundaries of each of the plurality of simplified boundary meshes into a respective internal simplified mesh, wherein each of the plurality of simplified meshes is associated with a respective block of the plurality of blocks; and generate a simplified global mesh for the plurality of blocks by merging the plurality of simplified meshes.

Aspect 2. The apparatus of Aspect 1, wherein each block of the plurality of blocks is a truncated signed distance function (TSDF) volume.

Aspect 3. The apparatus of any of Aspects 1 or 2, wherein the at least one processor is configured to generate the plurality of block meshes by performing surface extraction of the plurality of blocks.

Aspect 4. The apparatus of Aspect 3, wherein the surface extraction is based on a marching cubes algorithm.

Aspect 5. The apparatus of any of Aspects 1 to 4, wherein a block mesh of the plurality of block meshes comprises a plurality of vertices and a plurality of triangles for a block, and wherein, to generate the plurality of internal simplified meshes, the at least one processor is configured to generate an internal simplified mesh for the block based on simplifying vertices of the plurality of vertices located internal of the plurality of blocks.

Aspect 6. The apparatus of Aspect 5, wherein the at least one processor is configured to simplify the vertices of the plurality of vertices located internal of the plurality of blocks based on a quadric error measure.

Aspect 7. The apparatus of any of Aspects 1 to 6, wherein an internal simplified mesh of the plurality of internal simplified meshes comprises a plurality of vertices and a plurality of triangles, and wherein, to generate the plurality of unsimplified boundary meshes, the at least one processor is configured to generate an unsimplified boundary mesh associated with a block of the plurality of blocks based on merging vertices of the plurality of vertices located on boundaries of neighboring blocks of the plurality of blocks.

Aspect 8. The apparatus of Aspect 7, wherein the at least one processor is configured to generate the unsimplified boundary mesh further based on extracting triangles of the plurality of triangles connected to vertices of the plurality of vertices located on boundaries of the plurality of blocks.

Aspect 9. The apparatus of Aspect 8, wherein the at least one processor is configured to generate the unsimplified boundary mesh further based on extracting vertices of the plurality of vertices connected to the triangles of the plurality of triangles extracted from a corresponding internal simplified mesh of the plurality of internal simplified meshes.

Aspect 10. The apparatus of any of Aspects 1 to 9, wherein an unsimplified boundary mesh of the plurality of unsimplified boundary meshes comprises a plurality of vertices and a plurality of triangles, and wherein, to generate the plurality of simplified boundary meshes, the at least one processor is configured to: generate a simplified boundary mesh associated with a block of the plurality of blocks based on simplifying vertices of the plurality of vertices located on boundaries of the plurality of blocks.

Aspect 11. The apparatus of any of Aspects 1 to 10, wherein the at least one processor is configured to: determine a simplification rate; and generate the plurality of internal simplified meshes based on the determined simplification rate.

Aspect 12. The apparatus of Aspect 11, wherein the simplification rate is based on a number of triangles in a block mesh and a number of triangles in a simplified block mesh generated based on the block mesh.

Aspect 13. The apparatus of any of Aspects 11 or 12, wherein the simplification rate is based on a first simplification rate associated with the plurality of internal simplified meshes and a second simplification rate associated with the plurality of unsimplified boundary meshes.

Aspect 14. A method for image processing, the method comprising: generating a plurality of internal simplified meshes based on a plurality of block meshes for a plurality of blocks representing a scene, wherein each of the plurality of internal simplified meshes is associated with a respective block of the plurality of blocks; generating, based on the plurality of internal simplified meshes, a plurality of unsimplified boundary meshes for the plurality of blocks, wherein each of the plurality of unsimplified boundary meshes is associated with a respective block of the plurality of blocks; generating, based on the plurality of unsimplified boundary meshes, a plurality of simplified boundary meshes, wherein each of the plurality of simplified boundary meshes is associated with a respective block of the plurality of blocks; generating a plurality of simplified meshes by embedding simplified boundaries of each of the plurality of simplified boundary meshes into a respective internal simplified mesh, wherein each of the plurality of simplified meshes is associated with a respective block of the plurality of blocks; and generating a simplified global mesh for the plurality of blocks by merging the plurality of simplified meshes.

Aspect 15. The method of Aspect 14, wherein each block of the plurality of blocks is a truncated signed distance function (TSDF) volume.

Aspect 16. The method of any of Aspects 14 or 15, further comprising generating the plurality of block meshes by performing surface extraction of the plurality of blocks.

Aspect 17. The method of Aspect 16, wherein the surface extraction is based on a marching cubes algorithm.

Aspect 18. The method of any of Aspects 14 to 17, wherein: a block mesh of the plurality of block meshes comprises a plurality of vertices and a plurality of triangles for a block; and generating an internal simplified mesh for the block is based on simplifying vertices of the plurality of vertices located internal of the plurality of blocks.

Aspect 19. The method of any of Aspects 14 to 18, wherein simplifying the vertices of the plurality of vertices located internal of the plurality of blocks is based on a quadric error measure.

Aspect 20. The method of any of Aspects 14 to 19, wherein: an internal simplified mesh of the plurality of internal simplified meshes comprises a plurality of vertices and a plurality of triangles; and generating an unsimplified boundary mesh associated with a block of the plurality of blocks is based on merging vertices of the plurality of vertices located on boundaries of neighboring blocks of the plurality of blocks.

Aspect 21. The method of Aspect 20, wherein generating the unsimplified boundary mesh is further based on extracting triangles of the plurality of triangles connected to vertices of the plurality of vertices located on boundaries of the plurality of blocks.

Aspect 22. The method of Aspect 21, wherein generating the unsimplified boundary mesh is further based on extracting vertices of the plurality of vertices connected to the triangles of the plurality of triangles extracted from a corresponding internal simplified mesh of the plurality of internal simplified meshes.

Aspect 23. The method of any of Aspects 14 to 22, wherein: an unsimplified boundary mesh of the plurality of unsimplified boundary meshes comprises a plurality of vertices and a plurality of triangles; and generating a simplified boundary mesh associated with a block of the plurality of blocks is based on simplifying vertices of the plurality of vertices located on boundaries of the plurality of blocks.

Aspect 24. The method of any of Aspects 14 to 23, further comprising: determining a simplification rate; and generating the plurality of internal simplified meshes based on the determined simplification rate.

Aspect 25. The method of Aspect 24, wherein the simplification rate is based on a number of triangles in a block mesh and a number of triangles in a simplified block mesh generated based on the block mesh.

Aspect 26. The method of any of Aspects 24 to 25, wherein the simplification rate is based on a first simplification rate associated with the plurality of internal simplified meshes and a second simplification rate associated with the plurality of unsimplified boundary meshes.

Aspect 27. A non-transitory computer-readable medium having stored thereon instructions that, when executed by at least one processor, cause the at least one processor to perform operations according to any of Aspects 14 to 26.

Aspect 28. An apparatus for image processing, the apparatus including one or more means for performing operations according to any of Aspects 14 to 26.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
generate a plurality of internal simplified meshes based on a plurality of block meshes for a plurality of blocks representing a scene, wherein each of the plurality of internal simplified meshes is associated with a respective block of the plurality of blocks;
generate, based on the plurality of internal simplified meshes, a plurality of unsimplified boundary meshes for the plurality of blocks, wherein each of the plurality of unsimplified boundary meshes is associated with a respective block of the plurality of blocks;
generate, based on the plurality of unsimplified boundary meshes, a plurality of simplified boundary meshes, wherein each of the plurality of simplified boundary meshes is associated with a respective block of the plurality of blocks;
generate a plurality of simplified meshes by embedding simplified boundaries of each of the plurality of simplified boundary meshes into a respective internal simplified mesh, wherein each of the plurality of simplified meshes is associated with a respective block of the plurality of blocks; and
generate a simplified global mesh for the plurality of blocks by merging the plurality of simplified meshes.

2. The apparatus of claim 1, wherein each block of the plurality of blocks is a truncated signed distance function (TSDF) volume.

3. The apparatus of claim 1, wherein the at least one processor is configured to generate the plurality of block meshes by performing surface extraction of the plurality of blocks.

4. The apparatus of claim 3, wherein the surface extraction is based on a marching cubes algorithm.

5. The apparatus of claim 1, wherein a block mesh of the plurality of block meshes comprises a plurality of vertices and a plurality of triangles for a block, and wherein, to generate the plurality of internal simplified meshes, the at least one processor is configured to:
generate an internal simplified mesh for the block based on simplifying vertices of the plurality of vertices located internal of the plurality of blocks.

6. The apparatus of claim 5, wherein the at least one processor is configured to simplify the vertices of the plurality of vertices located internal of the plurality of blocks based on a quadric error measure.

7. The apparatus of claim 1, wherein an internal simplified mesh of the plurality of internal simplified meshes comprises a plurality of vertices and a plurality of triangles, and wherein, to generate the plurality of unsimplified boundary meshes, the at least one processor is configured to:
generate an unsimplified boundary mesh associated with a block of the plurality of blocks based on merging vertices of the plurality of vertices located on boundaries of neighboring blocks of the plurality of blocks.

8. The apparatus of claim 7, wherein the at least one processor is configured to generate the unsimplified boundary mesh further based on extracting triangles of the plurality of triangles connected to vertices of the plurality of vertices located on boundaries of the plurality of blocks.

9. The apparatus of claim 8, wherein the at least one processor is configured to generate the unsimplified boundary mesh further based on extracting vertices of the plurality of vertices connected to the triangles of the plurality of triangles extracted from a corresponding internal simplified mesh of the plurality of internal simplified meshes.

10. The apparatus of claim 1, wherein an unsimplified boundary mesh of the plurality of unsimplified boundary meshes comprises a plurality of vertices and a plurality of triangles, and wherein, to generate the plurality of simplified boundary meshes, the at least one processor is configured to:
generate a simplified boundary mesh associated with a block of the plurality of blocks based on simplifying vertices of the plurality of vertices located on boundaries of the plurality of blocks.

11. The apparatus of claim 1, wherein the at least one processor is configured to:
determine a simplification rate; and
generate the plurality of internal simplified meshes based on the determined simplification rate.

12. The apparatus of claim 11, wherein the simplification rate is based on a number of triangles in a block mesh and a number of triangles in a simplified block mesh generated based on the block mesh.

13. The apparatus of claim 11, wherein the simplification rate is based on a first simplification rate associated with the plurality of internal simplified meshes and a second simplification rate associated with the plurality of unsimplified boundary meshes.

14. A method for image processing, the method comprising:
generating a plurality of internal simplified meshes based on a plurality of block meshes for a plurality of blocks representing a scene, wherein each of the plurality of internal simplified meshes is associated with a respective block of the plurality of blocks;
generating, based on the plurality of internal simplified meshes, a plurality of unsimplified boundary meshes for the plurality of blocks, wherein each of the plurality of unsimplified boundary meshes is associated with a respective block of the plurality of blocks;
generating, based on the plurality of unsimplified boundary meshes, a plurality of simplified boundary meshes, wherein each of the plurality of simplified boundary meshes is associated with a respective block of the plurality of blocks;
generating a plurality of simplified meshes by embedding simplified boundaries of each of the plurality of simplified boundary meshes into a respective internal simplified mesh, wherein each of the plurality of simplified meshes is associated with a respective block of the plurality of blocks; and
generating a simplified global mesh for the plurality of blocks by merging the plurality of simplified meshes.

15. The method of claim 14, further comprising generating the plurality of block meshes by performing surface extraction of the plurality of blocks.

16. The method of claim 14, wherein:
a block mesh of the plurality of block meshes comprises a plurality of vertices and a plurality of triangles for a block; and
generating an internal simplified mesh for the block is based on simplifying vertices of the plurality of vertices located internal of the plurality of blocks.

17. The method of claim 16, wherein simplifying the vertices of the plurality of vertices located internal of the plurality of blocks is based on a quadric error measure.

18. The method of claim 14, wherein:
an internal simplified mesh of the plurality of internal simplified meshes comprises a plurality of vertices and a plurality of triangles; and
generating an unsimplified boundary mesh associated with a block of the plurality of blocks is based on merging vertices of the plurality of vertices located on boundaries of neighboring blocks of the plurality of blocks.

19. The method of claim 14, wherein:
an unsimplified boundary mesh of the plurality of unsimplified boundary meshes comprises a plurality of vertices and a plurality of triangles; and
generating a simplified boundary mesh associated with a block of the plurality of blocks is based on simplifying vertices of the plurality of vertices located on boundaries of the plurality of blocks.

20. The method of claim 14, further comprising:
determining a simplification rate; and
generating the plurality of internal simplified meshes based on the determined simplification rate.
